(19) United States
(12) Patent Application Publication
(10) Pub. No.: US 2008/0046774 A1
(43) Pub. Date: Feb. 21, 2008

(54) Blade Clustering System with SMP Capability and Redundant Clock Distribution Architecture Thereof

(75) Inventors: Tomonori Hirai, Fremont, CA (US); Jyh Ming Jong, Fremont, CA (US)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Tyan Computer Corporation, Taipei (TW)

(21) Appl. No.: 11/554,606

(22) Filed: Oct. 31, 2006

Related U.S. Application Data
(60) Provisional application No. 60/822,399, filed on Aug. 15, 2006.

(51) Int. Cl. G06F 1/00

(52) U.S. Cl. 713/500

(57) ABSTRACT

A redundant clock distribution architecture is provided for a blade clustering system to achieve SMP (symmetric multi-processor) capability and flexible system configuration. The architecture mainly provides a central clock signal from a central clock and a local clock signal from an operative local clock configured on each blade module of the system. A clock multiplexer selects the central clock signal and sends to plural local clock consumers on each blade module. The clock multiplexer switches to send the local clock signal if the central clock fails.

### BACKGROUND OF THE INVENTION

1. Field of Invention

The present invention relates to clock distribution in a compute system, and more particularly to redundant clock distribution architecture for a blade clustering system with SMP (symmetric multi-processor) capability.

2. Related Art

Nowadays, the actual demarcation between a SMP system and a blade clustering system is still difficult to be broken. Both systems are designed for certain purposes and operated in certain configuration. To combine the two types of systems as one, clock distribution will be one of the primary issues.

Generally, a reliable high-end SMP system has a redundant system clock distribution, while a typical blade system has dedicated local clock generation and distribution for each blade.

FIG. 1 shows an example for clock distribution of a high-end SMP system in the prior art. The system equipped with plural compute modules 120, 130 . . . 140 has a first central clock 111 and second central clock 112 as two identical clock sources, which exchange clock edge alignment information to maintain the same clock edge alignment. Two or more of the compute modules 120, 130, 140 . . . are connected with each other by system bus to enable one or more SMP domain. Each of the compute modules 120, 130, 140 receives two copies of clock signals generated and distributed from the first central clock 111 and second central clock 112. A multiplexer 121/131/141 may be used to switch between the two central clocks. If one of the first and second central clocks fails, the other needs to be used. That is because a typical SMP system usually requires synchronized or edge-aligned clock to make the whole system work. In addition, a local clock 122/132/142 may be implemented just for testing. However, generally the local clock 122/132/142 is disabled or suspended in normal operation because the local clock 122/132/142 is not synchronized or edge-aligned clock. As such, the local clock is a waste in either on-board space or capability for an on-going SMP system.

FIG. 2 shows a typical implementation of a blade clustering system 150 in the prior art. Since each of the blades 151, 152, 153 . . . is an independent computer running a different OS (operating system), the synchronized or edge-aligned clock distribution is not required. And if one local clock of the blades 151, 152, 153 . . . fails, the other blades will still continued to operate because each blade 151/152/153 is an independent computer. As long as a clustering management system can take care of the task scheduling/dispatching, the blade system is still available for new tasks. Therefore, most of the blade systems in the prior art do not have redundant clock(s). However, in the other hand, that means a conventional blade system does not have SMP capability among the blades due to its lack of synchronized or edge-aligned clock.

To achieve a flexible system configuration, such as bringing a SMP capability to a blade system, the architecture of clock generation and distribution needs to be rearranged in the first place.

### SUMMARY OF THE INVENTION

Accordingly, the present invention provides redundant clock distribution architecture for blade clustering system with SMP (symmetric multi-processor) capability. The present invention provides a large SMP capability to a blade clustering system by using a centralized clock and plural redundant local clocks.

In an embodiment of the present invention, the blade clustering system with SMP capability includes plural blade modules and a clock distribution architecture. Each of the blade modules includes plural local clock consumers. The clock distribution architecture includes a clock multiplexer and a operative local clock configured on each of the blade modules and a central clock. The central clock is used for generating a central clock signal. The clock multiplexer receives the central clock signal and a local clock signal generated from the local clock. The central clock signal is selected by the clock multiplexer and sent to the local clock consumers on each of the blade modules; wherein the clock multiplexer of the blade module switches from the central clock signal to send the local clock signal to the local clock consumers if the central clock fails.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 shows an example for clock distribution of a high-end SMP system in the prior art.

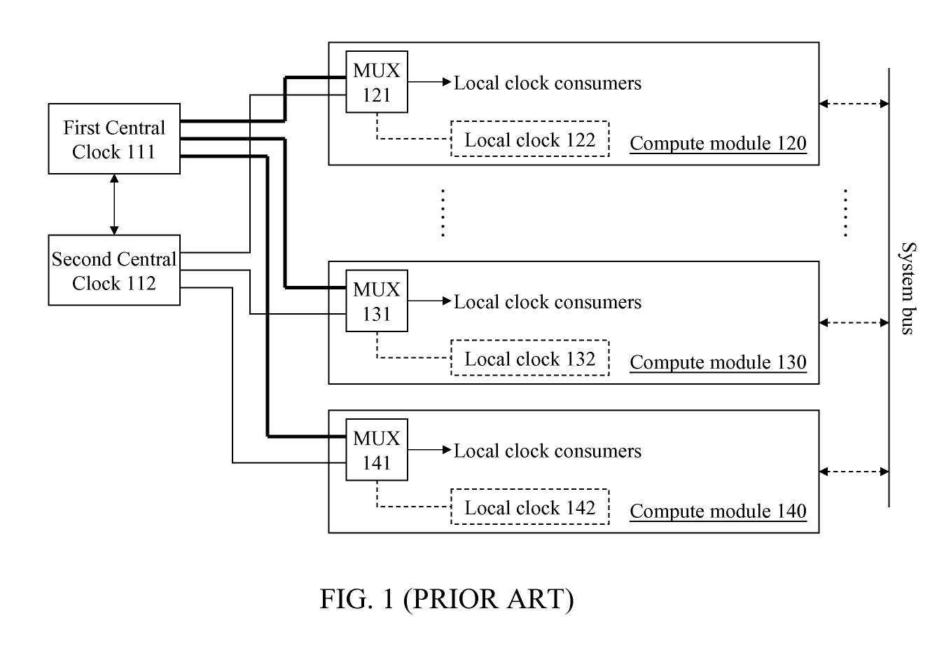

FIG. 2 shows a typical implementation of a blade system in the prior art.

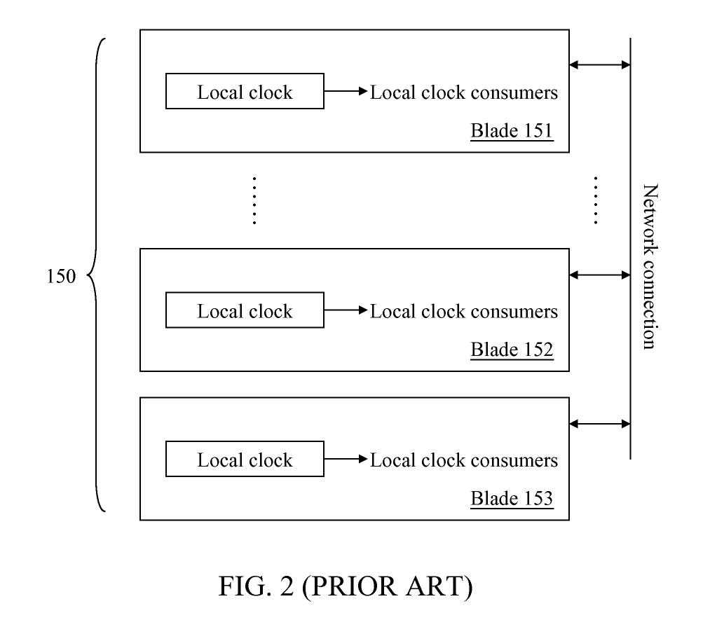

FIG. 3 shows a blade compute system with redundant clock architecture according to an embodiment of the present invention.

FIG. 4 shows the blade compute system in FIG. 3 configured under a single-blade operation mode.

FIG. 5 shows the blade compute system in FIG. 3 configured under a multi-blade operation mode.

### DETAILED DESCRIPTION OF THE INVENTION

The present invention provides redundant clock architecture to bring a high-end SMP system feature into a blade clustering system implementation, thereby enabling flexible system configuration.

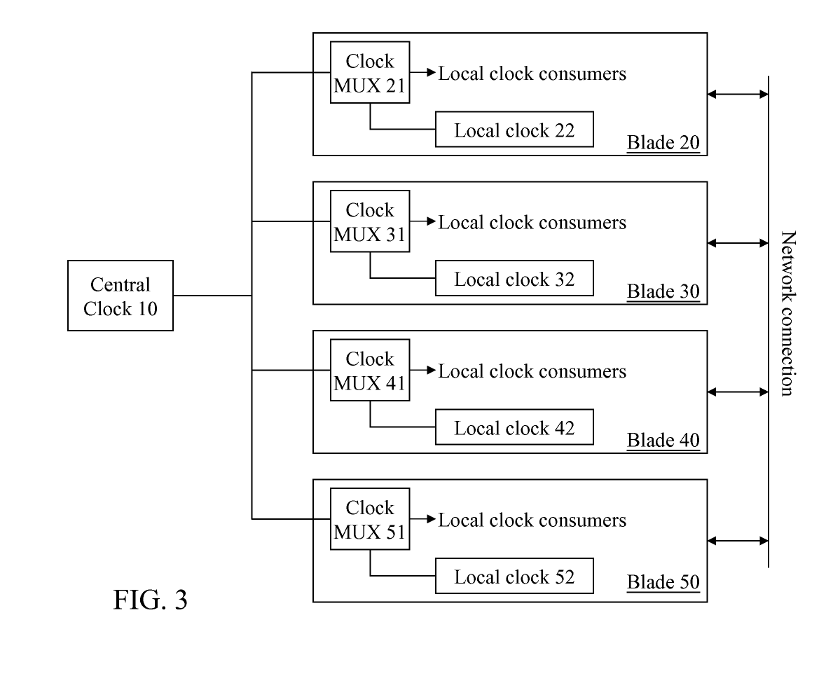

Please refer to FIG. 3. A blade clustering system mainly includes a central clock 10 and multiple blade modules 20, 30, 40, 50. The blade clustering system basically includes necessary hardware implementation and a clustering management system (both not shown) to manage the operations of the blade modules 20, 30, 40, 50. (To provide a clear explanation, other system components involved in the blade system are omitted in the drawings.) The clustering management system is a software program operating as a management/operation interface between the blade modules 20, 30, 40, 50 and the user. In the present invention, the clustering management system supports cluster computing, including asymmetric clustering and symmetric clustering with/without a head node.

Each blade module 20/30/40/50 may be considered as an independent computer, which is generally implemented on a mother board. The blade module 20/30/40/50 is embodied on a printed circuit board configured with various electrical components such as processor(s), system memory, bridge chip(s), I/O controllers, network interface controller(s), I/O connectors for expansion cards (all not shown), a clock multiplexer (MUX) 21/31/41/51 and local clock 22/32/42/52. These components connect each other by specific buses to perform data processing tasks. Each blade module 20/30/40/50 includes a dedicated operation system (OS) to execute direct monitoring and managing on hardware components configured thereon, manage all kinds of computing resources and provide an operative environment for application programs. In the present invention, the dedicated OS for each blade module 20/30/40/50 has capability to implement SMP configuration.

The processors (not shown) of the blades 20, 30, 40, 50 are single-chip processors configured in dedicated processor sockets (not shown), each equipped with one or more computing core. All the processors in the blade clustering system according to the present invention support various SMP configurations, such as 1, 2, 4 or 8 processor chips and etc. Namely, there may be more than one SMP domains existing in the blade clustering system.

The central clock 10, off-board configured or equipped on one of the blade modules 20, 30, 40, 50, generates and distributes a synchronized central clock signal to each of the blade modules 20, 30, 40, 50. In some specific cases, the central clock signal may be provided by the local clock of one of the blade modules 20, 30, 40, 50. To execute clustering tasks, the central clock 10 is controlled by the clustering management system.

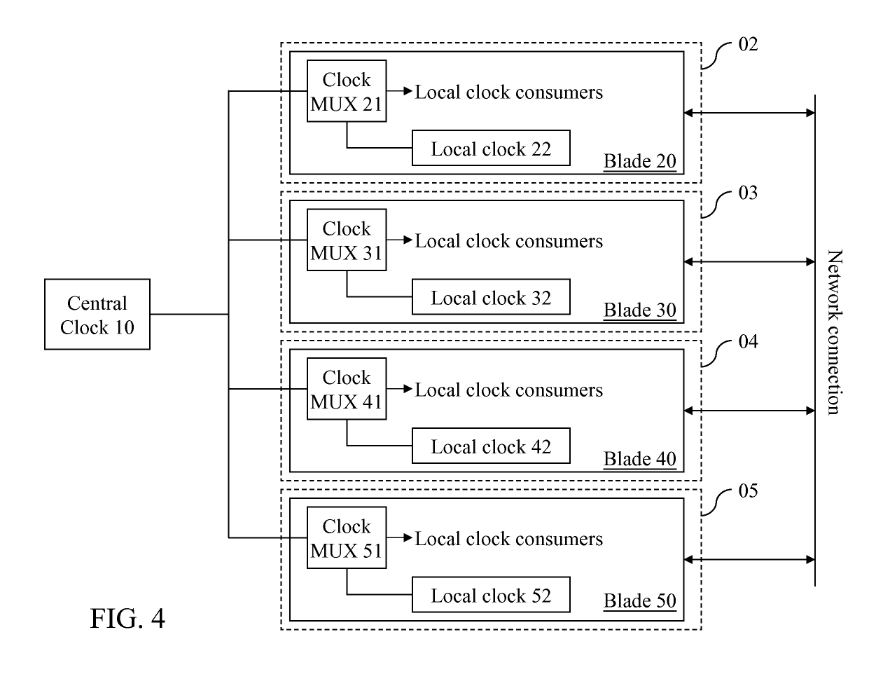

The local clock 22/32/42/52 is an independent clock source configured on each blade module 20/30/40/50, generating and distributing an operative local clock signal while the blade clustering system is operating. The local clock 22/32/42/52 can also be used for a standalone operation such as testing, debugging and trouble shooting. If the local clock 22/32/42/52 is capable of maintaining the same clock edge alignment, the blade clustering system can support a complete clock-fail-over feature with “single blade operation” (FIG. 4).

The clock multiplexer 21/31/41/51 connects electrically with the central clock 10, the local clock 22/32/42/52 and the local clock consumers on each blade module 20/30/40/50. The central clock signal and the local clock signal are sent to the clock multiplexer 21/31/41/51.

The clock multiplexer 21/31/41/51 monitors the clock signal status, also capable of selecting a healthy clock signal from the central clock signal and the local clock signal. By default the clock multiplexer 21/31/41/51 may select the central clock signal. If the selected clock signal has a problem and the other is healthy, the clock multiplexer 21/31/41/51 will switch over from a bad clock source to the other. A practical example of the clock multiplexer 21/31/41/51 is a select PLL, which is controlled by the clustering management system. The clustering management system of the blade clustering system monitors the clock status, controls clock distribution path and takes necessary actions to recover the blade clustering system.

Please refer to FIG. 4. In a single-blade operation mode, only one blade module 20/30/40/50 is involved for each OS domain Feb. 3, 2004/05. In this mode, the clock generation/distribution is completely redundant.

As a clustering system, the blade clustering system can use the central clock signal by default. Once the central clock 10 has failure or problem, the multiplexer 21/31/41/51 switches and the blade module 20/30/40/50 of the blade clustering system can use the local clock signal of its local clock 22/32/42/52, thereby remaining the blade module 20/30/40/50 to run. If the local clock 22/32/42 can maintain the local clock signal's edge aligned with the original central clock signal before it fails, the whole blade clustering system may keep synchronized clustering operation. Oppositely, without the local clock signals synchronized, each blade module 20/30/40/50 will still be running. As long as the cluster management system still processing the task scheduling/dispatching, the blade clustering system is still available for new tasks.

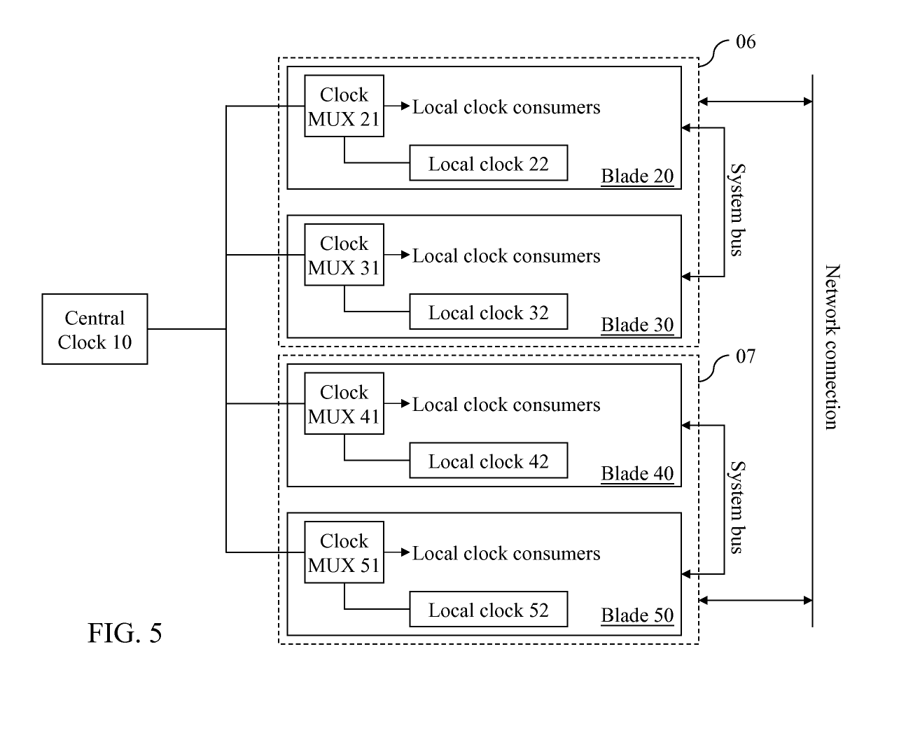

Please refer to FIG. 5. In a multi-blade operation mode, the processors of two blades (20, 30)/(40, 50) are connected by two system buses to form two or more SMP/OS domains 06, 07. A network connection is used to connect the SMP/OS domains 06, 07 for clustering. This configuration requires synchronized clock within the same SMP/OS domain 06, 07. In the embodiment, once the central clock 10 fails, the on-going tasks will not be recovered because the local clocks (22, 32)/(42, 52) cannot provide the processors involved in the same SMP/OS domain the synchronized clock signals. The system bus in the present invention may be embodied by any available electrical circuit connection between two or more processors to allow symmetric multi-processing, such as those buses compatible with HyperTransport protocols. The network connection includes practical high speed interfaces connecting between the network interface controllers of the blade modules, such as Infinite Band connection or Gigabyte Ethernet connection.

One solution is to utilize a synchronization module (not shown) for synchronizing the local clocks (22, 32)/(42, 52) in the same SMP/OS domain 06/07.

Another is to reboot the blade clustering system as “single-blade operation mode”. The clustering management system will recycle the power, change the SMP configuration and clock sources and restart system as “single-blade operation mode” again. Then the blade clustering system will still be usable without any repair/replacement. In the prior art, to replace or repair hardware configurations takes time. With the clock distribution architecture, the present invention provides an opportunity for the blade clustering system to keep operating for certain duration.

Using the central clock by default may be considered as a “full-redundant mode”. If somehow the blade clustering system cannot operates under the single-blade operation mode, then the clustering management system will need to recycle the power, change the clock sources and restart the system as “single-blade operation mode” again.

For those blades that need external clock source as a centralized clock, to test those blades will also rely on an extra clock source. This invention provides flexibility for standalone testing, debugging and trouble shooting. The blade could thus operate as a standalone.

Essential hardware implementation and/or software/firmware configuration would possibly need to be made to change the SMP configuration. The redundant clock distribution architecture of the present invention is one of the fundamentals for flexible system configuration.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A clock distribution architecture for a blade clustering system with SMP (symmetric multi-processor) capability, the blade clustering system including a plurality of blade modules, the clock distribution architecture comprising:
a central clock, generating a central clock signal; and
a clock multiplexer and a operative local clock configured on each of the blade modules, the clock multiplexer receiving the central clock signal and a local clock signal generated from the local clock, the central clock signal being selected by the clock multiplexer and sent to a plurality of local clock consumers on each of the blade modules;
wherein the clock multiplexer of the blade module switches from the central clock signal to send the local clock signal to the local clock consumers if the central clock fails.

2. The clock distribution architecture of claim 1, wherein the central clock signal is provided by the local clock of one of the blade modules.

3. The clock distribution architecture of claim 1 further comprising a synchronization module for synchronizing two or more of the local clock signals of the blade modules involved in at least one SMP domain.

4. The clock distribution architecture of claim 3, wherein a plurality of processors of the different blade modules in the same SMP are connected by a system bus.

5. The clock distribution architecture of claim 1, wherein the blade clustering system further comprising a network connection between the blade modules.

6. A blade clustering system with SMP (symmetric multi-processor) capability, comprising:
a plurality of blade modules, each including a plurality of local clock consumers; and
a clock distribution architecture comprising:
a central clock, generating a central clock signal; and
a clock multiplexer and a operative local clock configured on each of the blade modules, the clock multiplexer receiving the central clock signal and a local clock signal generated from the local clock, the central clock signal being selected by the clock multiplexer and sent to the local clock consumers on each of the blade modules;
wherein the clock multiplexer of the blade module switches from the central clock signal to send the local clock signal to the local clock consumers if the central clock fails.

7. The system of claim 6, wherein the central clock signal is provided by the local clock of one of the blade modules.

8. The system of claim 6, wherein the clock distribution architecture further comprises a synchronization module for synchronizing two or more of the local clock signals of the blade modules involved in at least one SMP domain.

9. The system of claim 8, wherein a plurality of processors of the different blade modules involved in the same SMP are connected by a system bus.

10. The system of claim 6 further comprising a network connection between the blade modules.
